(19) United States
(12) Patent Application Publication
(10) Pub. No.: US 2026/0211764 A1
(43) Pub. Date: Jul. 23, 2026

(54) INFORMATION PROCESSING SYSTEM, INFORMATION PROCESSING METHOD, AND NON-TRANSITORY COMPUTER READABLE MEDIUM

(71) Applicant: FUJIFILM Business Innovation Corp, Tokyo (JP)

(72) Inventors: Satomi KUDO, Kanagawa (JP); Takuto Mikada, Kanagawa (JP); Hideki Nojo, Kanagawa (JP)

(73) Assignee: FUJIFILM Business Innovation Corp, Tokyo (JP)

(21) Appl. No.: 19/299,877

(22) Filed: Aug. 14, 2025

(30) Foreign Application Priority Data
Jan. 22, 2025 (JP) 2025-009366

(51) Int. Cl. G06F 11/07

(52) U.S. Cl. CPC G06F 11/079; G06F 11/0709

(57) ABSTRACT

An information processing system includes: a storage; and a processor configured to: in response to a failure in an apparatus including multiple modules, acquire failure information from the storage; and execute a process associated with a failed module having the failure among the multiple modules and an operation mode of the apparatus at a time when the failure occurs, the process being executed by using the failure information.

### CROSS-REFERENCE TO RELATED APPLICATIONS

This application is based on and claims priority under 35 USC 119 from Japanese Patent Application No. 2025-009366 filed Jan. 22, 2025.

### BACKGROUND

### (i) Technical Field

The present disclosure relates to an information processing system, an information processing method, and a non-transitory computer readable medium.

### (ii) Related Art

Japanese Unexamined Patent Application Publication No. 2023-160058 describes the following. In an image forming apparatus 101, a scanner 102 optically reads an image from a document and converts the image into a digital image. A printer 104 outputs the digital image onto a paper device referred to as a paper sheet. An operation unit 105 includes: a touch panel for receiving setting operation for the image forming apparatus 101 from a user and displaying a processing state; and hard keys. A hard disk (HDD) 106 stores the digital image, a control program, and the like. The HDD 106 is a nonvolatile storage and may be a solid state drive (SSD), an embedded multimedia card (eMMC), or the like. A faxing device 107 transmits and receives the digital image to and from the telephone line or the like. A controller 103 is connected to the scanner 102, the printer 104, the operation unit 105, the hard disk 106, and the faxing device 107 and executes jobs on the image forming apparatus 101 by issuing instructions to modules.

Japanese Unexamined Patent Application Publication No. 9-258995 describes the following. The present disclosure relates to a computer system having a fault recovery mechanism based on a checkpoint rollback system that achieves fault resistance and particularly relates to a computer system having a fault recovery function related to a software failure attributed to a software bug or the like. In the checkpoint rollback system, when the computer system has a failure, data processing is performed again on the basis of a state before the occurrence of the failure.

### SUMMARY

An apparatus that provides multiple functions by using multiple modules is known (for example, see Japanese Unexamined Patent Application Publication No. 2023-160058). It is desired that if a failure occurs in such an apparatus, the apparatus be continuously operated by executing a process to prevent the recurrence of the failure. Analyses through many years have proved that an operation mode relates to the occurrence of a failure in the apparatus as described above.

Aspects of non-limiting embodiments of the present disclosure relate to an information processing system, an information processing method, and a non-transitory computer readable medium that are enabled to improve the availability of an apparatus including multiple modules if the apparatus has a failure as compared with a case without consideration of the operation mode at the time when the failure occurs.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including: a storage; and a processor configured to: in response to a failure in an apparatus including multiple modules, acquire failure information from the storage; and execute a process associated with a failed module having the failure among the multiple modules and an operation mode of the apparatus at a time when the failure occurs, the process being executed by using the failure information.

### BRIEF DESCRIPTION OF THE DRAWINGS

An exemplary embodiment of the present disclosure will be described in detail based on the following figures, wherein:

FIG. 1 is a view illustrating an example hardware configuration of an information processing system according to this exemplary embodiment together with a communication medium and a maintenance monitoring server;

FIG. 2 is a view illustrating an example software configuration of the information processing system according to this exemplary embodiment;

FIG. 3 is a view illustrating an example management table usable by the information processing system according to this exemplary embodiment; and

FIG. 4 is an example flowchart of an information processing method performed by the information processing system according to this exemplary embodiment.

### DETAILED DESCRIPTION

Hereinafter, an example of an exemplary embodiment of the present disclosure will be described with reference to the drawings. The same or equivalent components and parts are denoted by the same reference numerals throughout the drawings. The ratio of the dimensions of each drawing is exaggerated for convenience of explanation and is different from the actual ratio on occasions.

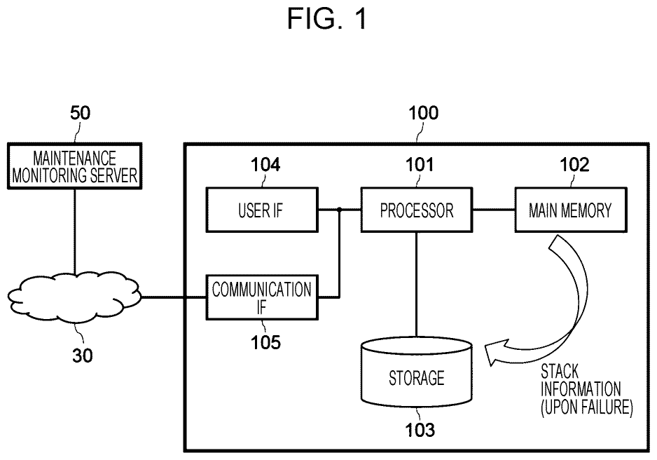

FIG. 1 is a view illustrating an example hardware configuration of an information processing system 100 according to this exemplary embodiment together with a communication medium 30 and a maintenance monitoring server 50. In controlling an apparatus, a hang-up (also referred to as a hang) or a crash occurs on occasions. A hang-up denotes a state where software and a system do not receive any operation and do not respond. A crash denotes an event in which the software and the system are terminated abnormally and are forced to stop.

The hang-up and the crash are not restored automatically over time unlike a freeze. Accordingly, if the apparatus has such a failure, the operations thereof become not continuable. The failure to be addressed in the present disclosure may include at least one of a hang-up or a crash in software that controls the apparatus in this manner.

If the failure as described above occurs, recovery is performed through automatic reset using a watch dog timer (WDT) or the like. However, if a configuration, a function, hardware, or the like causing the failure is still in the state without any change, the failure recurs after the recovery. To prevent the recurrence as described above, recurrence prevention measures are required to be taken by performing configuration change, software update, hardware replacement, or the like.

In contrast, in the related art, a customer engineer collects logs, a developer analyzes the logs and plans a recurrence prevention measure, the customer engineer addresses the failure in accordance with the recurrence prevention measure. However, there is an issue, in the measure in the related art, that it takes time to take the measure and incurs cost of the customer engineer and the developer.

A conceivable way of addressing the issue as described above is improving the availability of the apparatus by automatically deciding a recurrence prevention measure after autonomously analyzing the cause. The availability herein denotes the degree or a capability of the continuous system operation. Japanese Unexamined Patent Application Publication No. 9-258995 discloses the computer system having the fault recovery mechanism. However, since the operation mode of the apparatus at the time when the failure occurs is not considered in the technology in Japanese Unexamined Patent Application Publication No. 9-258995, and it is not possible to perform a process associated with the operation mode. Accordingly, it has not been possible to sufficiently improve the availability of the apparatus with the technology in the related art.

In the information processing system 100 according to this exemplary embodiment, in response to the occurrence of a failure in an apparatus including multiple modules, the process associated with a failed module having the failure and the operation mode of the apparatus at the time when the failure occurs is executed by using failure information. Accordingly, with the information processing system 100 according to this exemplary embodiment, the availability of the apparatus may be improved as compared with the case without consideration of the operation mode at the time when the failure occurs. The information processing system 100 as described above will be described in detail.

The information processing system 100 may be communicatively connected to the maintenance monitoring server 50 via the communication medium 30. The communication medium 30 connects multiple computers communicatively. FIG. 1 illustrates, as an example, a case where the information processing system 100 and the maintenance monitoring server 50 are connected to each other via the communication medium 30. The communication medium 30 may be, for example, the Internet. However, the communication medium 30 is not limited to this. The communication medium 30 may be any medium that enables multiple computers to be communicatively connected, such as a local area network (LAN), a wide area network (WAN), or an intranet.

The maintenance monitoring server 50 collects information regarding a failure or a process from the information processing system 100 and stores the information. The maintenance monitoring server 50 may also be configured to be able to receive a request from the information processing system 100 and transmit information meeting the request or an execution result to the information processing system 100. The maintenance monitoring server 50 may be implemented by, for example, cloud computing. FIG. 1 illustrates, as an example, a case where the maintenance monitoring server 50 is one apparatus; however, the maintenance monitoring server 50 may, in a distributed manner, store pieces of information in multiple apparatuses and execute processes.

The information processing system 100 is a controller that controls an apparatus. The apparatus serving as a control target is an apparatus that provides multiple functions by using multiple modules. As examples of the apparatus as described above, a multifunction peripheral capable of providing functions of a copier, a scanner, a fax machine, and the like are cited.

The information processing system 100 may be a computer and may also include a processor 101, a main memory 102, a storage 103, a user interface 104, and a communication interface 105. These components may be connected mutually communicatively via a bus.

The processor 101 runs various programs and controls the components. The processor 101 may be, for example, a central processing unit (CPU).

The main memory 102 serves as a work area and temporarily stores a program or data. The main memory 102 may be, for example, a dynamic random access memory (DRAM).

The storage 103 is a nonvolatile storage capable of holding data even if power is turned off and stores various programs including the operating system and various pieces of data. The storage 103 may be, for example, a solid state drive (SSD).

The user interface 104 is an input/output interface for the information processing system 100 to exchange information with a user (including the customer engineer). The user interface 104 may include a touch panel, a keyboard, a mouse, a microphone, and the like as an input unit and a monitor, the speaker, and the like as an output unit.

The communication interface 105 is an interface for the information processing system 100 to communicate with a different apparatus. FIG. 1 illustrates only the maintenance monitoring server 50 as the different apparatus as an example; however, the different apparatus is not limited to this.

Since the capacity of only the internal register in the processor 101 is not sufficient in running a program, information is temporarily stored in the main memory 102 on occasions. The information as described above is referred to as stack information.

A program is composed of instructions that describe, in order, processes to be executed by the computer. If a failure occurs under the circumstances as described above and prevents the processes from being executed in the order described by the program, the processor 101 generates an interruption and thus terminates the program. The processor 101 thereby stops the system reliably. To perform the interruption, the processor 101 saves the stack information from the main memory 102 into the storage 103.

The stack information as described above includes a program counter value of the original program run by the processor 101 before the interruption and information regarding the internal state of the processor 101. The stack information as described above may thus be used for analysis as failure information at the time when the failure occurs.

The processor 101 may thus store the failure information in the storage 103 when the failure occurs. At this time, the processor 101 may store, in the storage 103, at least one of information regarding the program run by the processor 101 or information regarding the internal state of the processor 101, as the failure information. The processor 101 may acquire the failure information from the storage 103 after a reset. The processor 101 executes a process associated with the failed module having the failure and the operation mode of the apparatus at the time when the failure occurs, by using the failure information acquired, for example, in this manner.

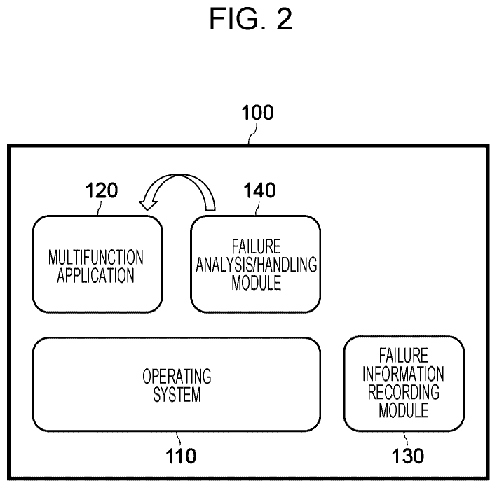

FIG. 2 is a view illustrating an example software configuration of the information processing system 100 according to this exemplary embodiment. The information processing system 100 includes an operating system 110, a multifunction application 120, a failure information recording module 130, and a failure analysis/handling module 140.

The operating system 110 is system software that takes charge of operation of the computer.

The multifunction application 120 is an application for the apparatus to provide the multiple functions. The multifunction application 120 may be, for example, a multi-function peripheral (MFP) application. The operating system 110 and the multifunction application 120 may be the same as existing systems and applications, and thus detailed description thereof is omitted.

The failure information recording module 130 is a handler allowed to run independently of major processes of the operating system 110. When a hang, a crash, or the like occurs in the operating system 110, the failure information recording module 130 is called and saves the stack information from the main memory 102. The failure information recording module 130 then stores the stack information in the storage 103 and resets the system.

The failure analysis/handling module 140 is software that runs on the operating system 110. The failure analysis/handling module 140 reads out the stack information as the failure information from the storage 103 after the reset. The failure analysis/handling module 140 traces back the function calling records of the operating system 110 by using the failure information and thereby finds the failed module having the failure and the operation mode of the apparatus at the time when the failure occurs.

The failure analysis/handling module 140 may then decide a response to the failure on the basis of the found failed module and the operation mode. Major responses at this time may be, for example, configuration change, displaying on the user interface 104, and transmitting information to the maintenance monitoring server 50. The failure analysis/handling module 140 may give an instruction to the multifunction application 120 according to the decided response. In this exemplary embodiment, when deciding the response, the failure analysis/handling module 140 may use a management table in which approaches are defined on a per module basis.

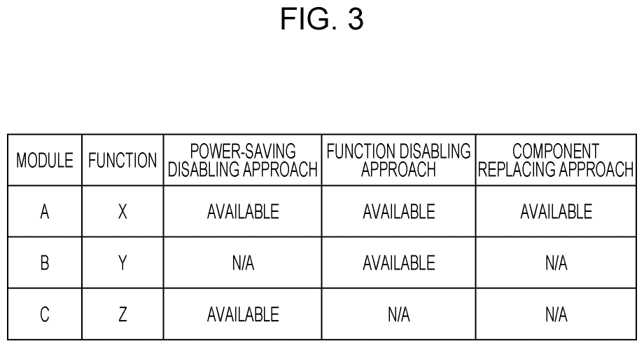

FIG. 3 is a view illustrating an example management table usable by the information processing system 100 according to this exemplary embodiment. For convenience of explanation, FIG. 3 illustrates, as an example, a case where the apparatus provides a function X, a function Y, and a function Z by using a module A, a module B, and a module C, respectively. However, the number of modules and functions is not limited to this.

The item “power-Saving disabling approach” represents priority of a function compared to the power-saving function. Available for the item denotes that the power-saving function is assigned a lower priority than the function. N/A for the item denotes that the power-saving function is assigned a higher priority than the function. FIG. 3 thus illustrates, as an example, a case where the power-saving function is assigned a lower priority than the functions X and Z and a higher priority than the function Y.

The item “function disabling approach” represents whether disabling a function is available. Available for the item denotes that separately disabling the function is available. N/A for the item denotes that separately disabling the function is not available. FIG. 3 thus illustrates, as an example, a case where separately disabling the functions X and Y is available, whereas separately disabling the function Z is not available.

The item “component replacing approach” represents whether the replacement of a relevant component is available. Available for the item denotes that the relevant component is replaceable. N/A for the item denotes that the relevant component is not replaceable. FIG. 3 thus illustrates, as an example, a case where a component relevant to the module A is replaceable, whereas a component relevant to the modules B and C is not replaceable.

The component replacing approach may be replacing a component relevant to the failed module, that is, replacing hardware with normal hardware. For example, assume that the failed module is a device driver that provides a Wi-Fi (registered trademark) function. In this case, the component replacing approach may be replacing a Wi-Fi adapter or a Wi-Fi card with a normal device. An approach in which a failed component is replaced as described above leads to elimination of the cause of the failure and thus enables recurrence to be prevented. Accordingly, it may be said that the component replacing approach is a permanent recurrence prevention measure.

In contrast, the power-saving disabling approach is stopping a predetermined operation mode of the apparatus, that is, the power saving mode. The function disabling approach is stopping a function corresponding to the failed module. For example, assume that the failed module is a device driver that provides the faxing function. In this case, the function disabling approach may be stopping the faxing function. As described above, the power-saving disabling approach and the function disabling approach do not eliminate the cause of the failure itself, and thus it may be said that the power-saving disabling approach and the function disabling approach are temporary recurrence prevention measures.

The approach in which a component is replaced, the approach in which a predetermined operation mode of the apparatus is stopped, and the approach in which the function corresponding to the failed module is stopped are respectively referred to as a first approach, a second approach, and a third approach. The storage 103 may thus store, in advance, the management table representing whether an approach serving as the first approach, the second approach, or the third approach is available to one of the multiple modules. The processor 101 may decide a response to the failure by using the management table as described above and execute a process associated with the first approach, the second approach, or the third approach. An information processing method performed by the information processing system 100 according to this exemplary embodiment will be described in detail by using a flow.

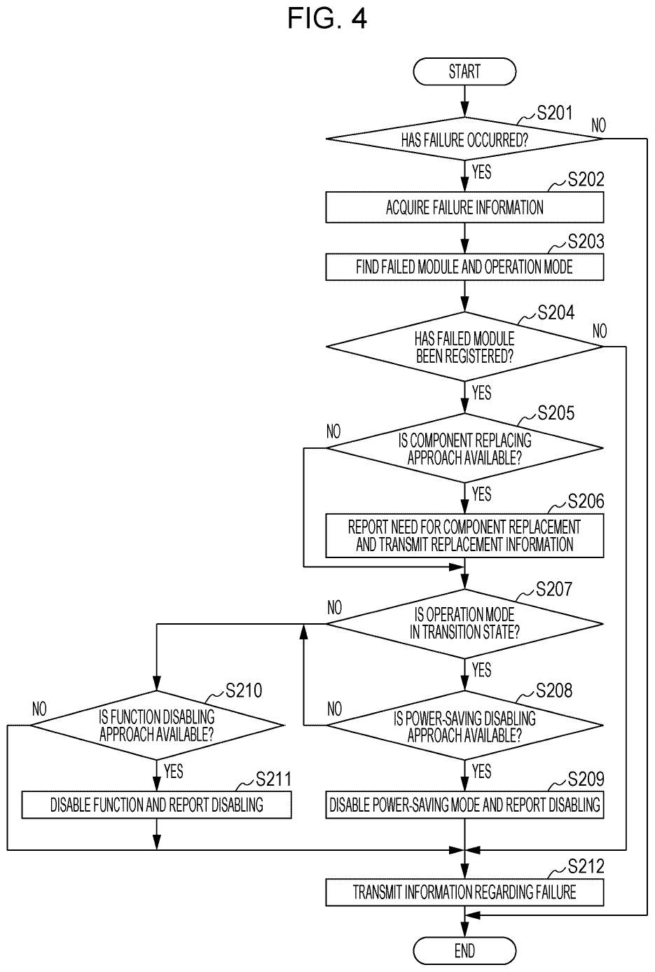

FIG. 4 is an example flowchart of the information processing method performed by the information processing system 100 according to this exemplary embodiment. This flow may be implemented in such a manner that the processor 101 reads out an information processing program (not illustrated) from the storage 103 and loads the program into the main memory 102 as a work area. This flow may also be started when the apparatus is started.

In step S201, the processor 101 determines whether a predetermined failure has occurred at the time of previous operation. The processor 101 may check, for example, information recorded by the failure information recording module 130 at the time of previous operation. The processor 101 may determine whether a hang or a crash has occurred on the basis of the information. If a hang or a crash has not occurred, the processor 101 may make a determination of “No” and terminate this flow. In contrast, if a hang or a crash has occurred, the processor 101 may make a determination of “Yes” and proceed to step S202.

If a failure has occurred at the time of previous operation, the processor 101 may have stored the failure information in the storage 103 when the failure occurs, as described above. In this case, the processor 101 may have stored, in the storage 103, the stack information including at least one of the information regarding the program run by the processor 101 or the information regarding the internal state of the processor 101, as the failure information.

In step S202, the processor 101 acquires the failure information. The processor 101 may read out, for example, the stack information as the failure information from the storage 103 after the reset, the stack information having been saved from the main memory 102 before the reset. If the apparatus including the multiple modules has a failure, the processor 101 may acquire the failure information from the storage 103 after the reset, for example, in this manner.

In step S203, the processor 101 finds a failed module having the failure among the multiple modules and the operation mode of the apparatus at the time when the failure occurs. The processor 101 may find the failed module and the operation mode by tracing back the function calling records of the operating system 110 by using the failure information acquired, for example, in step S202.

In step S204, the processor 101 determines whether the failed module has been registered in the management table. The processor 101 may determine whether the failed module found, for example, in step S203 has been registered in the management table illustrated in FIG. 3. If the failed module has not been registered in the management table, the processor 101 may make a determination of “No” and proceed to step S212. In contrast, if the failed module has been registered in the management table, the processor 101 may make a determination of “Yes” and proceed to step S205.

In step S205, the processor 101 determines whether the component replacing approach is available to the failed module. For the failed module, the processor 101 may refer to, for example, the item “component replacing approach” in the management table illustrated in FIG. 3. If the item has the value N/A, the processor 101 may make a determination of “No” and proceed to step S207. In contrast, if the item has the value Available, the processor 101 may make a determination of “Yes” and proceed to step S206.

In step S206, the processor 101 reports the need for component replacement to the user and transmits replacement information to the maintenance monitoring server 50. The processor 101 may display, on the monitor, for example, the message “A component a related to the module A needs to be replaced. The component a will be prepared and please replace the component a”. The processor 101 may report, to the user, a message associated with the process by using the user interface 104, for example, in this manner.

The processor 101 may also transmit, to the maintenance monitoring server 50, the message “Component preparation request: component a for Apparatus PP in installation place QQ” or the like. The processor 101 may transmit, to the maintenance monitoring server 50, a message associated with the process by using the communication interface 105, for example, in this manner.

In step S207, the processor 101 determines whether the operation mode of the apparatus at the time when the failure occurs is in a predetermined transition state. The processor 101 may determine whether the operation mode found, for example, in step S203 is in a moving state representing moving to the power saving mode or a restored state representing restoration from the power saving mode. If the operation mode is not in the moving state or the restoration state, the processor 101 may make a determination of “No” and proceed to step S210. In contrast, if the operation mode is in the moving state or the restoration state, the processor 101 may make a determination of “Yes” and proceed to step S208.

In step S208, the processor 101 determines whether the power-saving disabling approach is available to the failed module. For the failed module, the processor 101 may refer to the item “power-Saving disabling approach” in the management table illustrated, for example, in FIG. 3. If the item has the value N/A, the processor 101 may make a determination of “No” and proceed to step S210. In contrast, if the item has the value Available, the processor 101 may make a determination of “Yes” and proceed to step S209.

In step S209, the processor 101 disables the power saving mode and reports the disabling to the user. For example, the processor 101 may temporarily delete the power saving mode from the operation modes of the apparatus. The processor 101 may then display, on the monitor, the message “Due to a failure, moving to the power saving mode is prohibited at present.” or the like. The processor 101 may also report, to the user, a message associated with the process by using the user interface 104, for example, in this manner.

In step S210, the processor 101 determines whether the function disabling approach is available to the failed module. For the failed module, the processor 101 may refer to the item “function disabling approach” in the management table illustrated, for example, in FIG. 3. If the item has the value N/A, the processor 101 may make a determination of “No” and proceed to step S212. In contrast, if the item has the value Available, the processor 101 may make a determination of “Yes” and proceed to step S211.

In step S211, the processor 101 disables the function corresponding to the failed module and reports the disabling to the user. For example, the processor 101 may temporarily delete the function corresponding to the failed module from the functions of the apparatus. The processor 101 may display, on the monitor, the message “Due to a failure, the function Y is not available at present.” or the like. The processor 101 may also report, to the user, a message associated with the process by using the user interface 104, for example, in this manner.

In step S212, the processor 101 transmits information regarding the failure to the maintenance monitoring server 50. The processor 101 may transmit the failure information acquired, for example, in step S202 to the maintenance monitoring server 50. Instead of or in addition to this, the processor 101 may transmit, to the maintenance monitoring server 50, the information regarding the failed module and the operation mode found, for example, in step S203. If the failure is a hardware failure, the issue may be addressed by replacing the component prepared in step S206. In contrast, if the failure is a software failure, the issue may be addressed by analyzing the information transmitted in step S212 by the developer.

As described above, the information processing system 100 according to this exemplary embodiment includes the processor 101 and the storage 103. In response to a failure in an apparatus including multiple modules, the processor 101 acquires failure information from a recording device and executes a process associated with a failed module having the failure among the multiple modules and the operation mode of the apparatus at the time when the failure occurs, the process being executed by using the failure information. Accordingly, with the information processing system 100 according to this exemplary embodiment, if a failure occurs in the apparatus including the multiple modules, the availability of the apparatus may be improved as compared with the case without consideration of the operation mode at the time when the failure occurs.

In this case, the processor 101 may execute a different process depending on whether the operation mode is in the predetermined transition state. Accordingly, with the information processing system 100 according to this exemplary embodiment, if the operation mode of the apparatus at the time when the failure occurs is in a specific transition state, a special process different from a process to be executed not in the specific transition state may be executed.

The predetermined transition state may include at least one of the moving state representing moving to the power saving mode or the restored state representing restoration from the power saving mode. It has proved that if a control target is an apparatus that provides multiple functions by using multiple modules, a failure causing not continuable operations occurs frequently particularly when the apparatus transitions to a low power consumption state and restores from the low power consumption state. Accordingly, with the information processing system 100 according to this exemplary embodiment, a special process may be executed focused on the case where a failure is likely to occur.

The processor 101 executes a process associated with the substance of the approach for addressing the failure, on the basis of the failed module and the operation mode. It is not practical to map the substance of the approach to every process of the operating system 110. In contrast, with the information processing system 100 according to this exemplary embodiment, the substance of the approach may be mapped, limiting to two features of the module having the failure and the operation mode of the apparatus at the time when the failure occurs.

In this case, the substance of the approach may include at least one of the first approach in which a component for a failed module is replaced, the second approach in which a predetermined operation mode of the apparatus is stopped, or the third approach in which a function corresponding to the failed module is stopped. Accordingly, with the information processing system 100 according to this exemplary embodiment, the failure may be addressed by using wide-range recurrence prevention measures ranging from a temporary measure to a permanent measure.

In this case, the storage 103 stores the management table representing whether an approach serving as the first approach, the second approach, or the third approach is available to one of the multiple modules, and the processor 101 may execute a process associated with the first approach, the second approach, or the third approach by using the management table. Accordingly, with the information processing system 100 according to this exemplary embodiment, which one of the first approach, the second approach, and the third is to be adopted may be decided readily by only preparing the table in which available approaches are defined in advance on a per-module basis.

The processor 101 may also store the failure information in the storage 103 when a failure occurs and acquire failure information from the storage 103 after the reset. Accordingly, with the information processing system 100 according to this exemplary embodiment, a new system for storing information different from information stored in the computer due to a general interruption process does not have to be employed.

In this case, the processor 101 stores at least one of the information regarding the program run by the processor 101 and the information regarding the internal state of the processor 101 as the failure information in the storage 103. Accordingly, with the information processing system 100 according to this exemplary embodiment, the failed module having the failure and the operation mode of the apparatus at the time when the failure occurs may be found by tracing back the function calling records of the operating system 110.

The processor 101 may also report a message associated with the process to the user by using the user interface 104. Accordingly, with the information processing system 100 according to this exemplary embodiment, a change made without the user's awareness may be prevented, such as configuration change or component replacement.

The processor 101 may also transmit, to the maintenance monitoring server 50, at least one of a message associated with the process or the information regarding the failure by using the communication interface 105. Accordingly, with the information processing system 100, the failure and the process may be shared with the server.

The failure may include at least one of a hang-up or a crash in the software that controls the apparatus. Accordingly, with the information processing system 100 according to this exemplary embodiment, a failure that is not to be restored automatically over time and that is likely to cause not continuable operation situation may be handled.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

The present disclosure is not limited to the exemplary embodiments described above. It goes without saying that the exemplary embodiments may be implemented in such a manner as not only described above but also to be modified variously without departing from the spirit of the disclosure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system includes: a storage; and a processor configured to: in response to a failure in an apparatus including multiple modules, acquire failure information from the storage; and execute a process associated with a failed module having the failure among the multiple modules and an operation mode of the apparatus at a time when the failure occurs, the process being executed by using the failure information.
(((2)))

In the information processing system according to (((1))), the processor is configured to execute a different process depending on whether the operation mode is in a predetermined transition state.
(((3)))

In the information processing system according to (((2))), the predetermined transition state includes at least one of a moving state representing moving to a power saving mode or a restored state representing restoration from the power saving mode.
(((4)))

In the information processing system according to any one of (((1))) to (((3))), the processor is configured to execute the process associated with substance of an approach for addressing the failure, the process being executed on a basis of the failed module and the operation mode.
(((5)))

In the information processing system according to (((4))), the substance of the approach includes at least one of a first approach in which a component for the failed module is replaced, a second approach in which a predetermined operation mode of the apparatus is stopped, or a third approach in which a function corresponding to the failed module is stopped.
(((6)))

In the information processing system according to (((5))), the storage stores a management table representing whether an approach serving as the first approach, the second approach, or the third approach is available to one of the multiple modules, and the processor is configured to execute the process associated with the first approach, the second approach, or the third approach by using the management table.
(((7)))

In the information processing system according to any one of (((1))) to (((6))), the processor is configured to store the failure information in the storage when the failure occurs; and acquire the failure information from the storage after a reset.
(((8)))

In the information processing system according to (((7))), the processor is configured to store, in the storage, at least one of information regarding a program run by the processor and information regarding an internal state of the processor, as the failure information.
(((9)))

In the information processing system according to any one of (((1))) to (((8))), the processor is configured to report a message to a user by using a user interface, the message being associated with the process.
(((10)))

In the information processing system according to any one of (((1))) to (((9))), the processor is configured to by using a communication interface, transmit at least one of a message associated with the process or information regarding the failure to a maintenance monitoring server.
(((11)))

In the information processing system according to any one of (((1))) to (((10))), the failure includes at least one of a hang-up or a crash in software that controls the apparatus.
(((12)))

An information processing method includes: in response to a failure in an apparatus including multiple modules, acquiring failure information from a storage; and executing a process associated with a failed module having the failure among the multiple modules and an operation mode of the apparatus at a time when the failure occurs, the process being executed by using the failure information.
(((13)))

An information processing program causes a computer to execute a process for information processing, the process including: in response to a failure in an apparatus including multiple modules, acquiring failure information from a storage; and executing a process associated with a failed module having the failure among the multiple modules and an operation mode of the apparatus at a time when the failure occurs, the process being executed by using the failure information.

What is claimed is:

1. An information processing system comprising:
a storage; and
a processor configured to:
in response to a failure in an apparatus including a plurality of modules, acquire failure information from the storage; and
execute a process associated with a failed module having the failure among the plurality of modules and an operation mode of the apparatus at a time when the failure occurs, the process being executed by using the failure information.

2. The information processing system according to claim 1,
wherein the processor is configured to execute a different process depending on whether the operation mode is in a predetermined transition state.

3. The information processing system according to claim 2,
wherein the predetermined transition state includes at least one of a moving state representing moving to a power saving mode or a restored state representing restoration from the power saving mode.

4. The information processing system according to claim 1,
wherein the processor is configured to execute the process associated with substance of an approach for addressing the failure, the process being executed on a basis of the failed module and the operation mode.

5. The information processing system according to claim 4,
wherein the substance of the approach includes at least one of a first approach in which a component for the failed module is replaced, a second approach in which a predetermined operation mode of the apparatus is stopped, or a third approach in which a function corresponding to the failed module is stopped.

6. The information processing system according to claim 5,
wherein the storage stores a management table representing whether an approach serving as the first approach, the second approach, or the third approach is available to one of the plurality of modules, and
wherein the processor is configured to execute the process associated with the first approach, the second approach, or the third approach by using the management table.

7. The information processing system according to claim 1,
wherein the processor is configured to:
store the failure information in the storage when the failure occurs; and
acquire the failure information from the storage after a reset.

8. The information processing system according to claim 7,
wherein the processor is configured to: store, in the storage, at least one of information regarding a program run by the processor and information regarding an internal state of the processor, as the failure information.

9. The information processing system according to claim 1,
wherein the processor is configured to report a message to a user by using a user interface the message being associated with the process.

10. The information processing system according to claim 2,
wherein the processor is configured to report a message to a user by using a user interface the message being associated with the process.

11. The information processing system according to claim 3,
wherein the processor is configured to report a message to a user by using a user interface the message being associated with the process.

12. The information processing system according to claim 4,
wherein the processor is configured to report a message to a user by using a user interface the message being associated with the process.

13. The information processing system according to claim 5,
wherein the processor is configured to report a message to a user by using a user interface the message being associated with the process.

14. The information processing system according to claim 6,
wherein the processor is configured to report a message to a user by using a user interface the message being associated with the process.

15. The information processing system according to claim 7, wherein the processor is configured to report a message to a user by using a user interface, the message being associated with the process.

16. The information processing system according to claim 8, wherein the processor is configured to report a message to a user by using a user interface, the message being associated with the process.

17. The information processing system according to claim 1,
wherein the processor is configured to by using a communication interface, transmit at least one of a message associated with the process or information regarding the failure to a maintenance monitoring server.

18. The information processing system according to claim 1,
wherein the failure includes at least one of a hang-up or a crash in software that controls the apparatus.

19. An information processing method comprising:
in response to a failure in an apparatus including a plurality of modules, acquiring failure information from a storage; and
executing a process associated with a failed module having the failure among the plurality of modules and an operation mode of the apparatus at a time when the failure occurs, the process being executed by using the failure information.

20. A non-transitory computer readable medium storing a program causing a computer to execute a process for information processing, the process comprising:
in response to a failure in an apparatus including a plurality of modules, acquiring failure information from a storage; and
executing a process associated with a failed module having the failure among the plurality of modules and an operation mode of the apparatus at a time when the failure occurs, the process being executed by using the failure information.
